(19) United States
(12) Patent Application Publication
(10) Pub. No.: US 2006/0055779 A1
(43) Pub. Date: Mar. 16, 2006

(54) Surveillance system for application in taxis

(75) Inventor: Kin Keung Dennis Li, Hong Kong (HK)

Correspondence Address: Mr. Eric Chan, 42 Pin Oaks Drive, Phoenixville, PA, 19460, US

(73) Assignee: MULTIVISION INTELLIGENT SURVEILLANCE (HONG KONG) LIMITED, Hong Kong (HK)

(21) Appl. No.: 11/223,106

(22) Filed: Sep. 12, 2005

(30) Foreign Application Priority Data
Sep. 14, 2004 (HK) 04106999.4

(51) Int. Cl. H04N 7/18; H04N 9/47

(52) U.S. Cl. 348/148

(57) ABSTRACT

The present invention relates to a surveillance system for application in taxis comprising hidden video camera(s), a server, wireless networking facilities, an emergency switch and a central monitoring station in a taxi. The circuit board of the server has a microprocessor installed with software which automatically compresses temporary image backup files and transmits them by long-distance real time transmission via the wireless networking facilities to the central monitoring station for surveillance and permanent backup storage. The present invention effectively prevent offenders from damaging or stealing recorded images stored inside the taxis and destroying evidence of crime.

### BACKGROUND OF THE INVENTION

The present invention relates to a surveillance system for application in transportation and more particularly pertains to a surveillance system for application in taxis in the field of digital image transmission.

Taxi drivers are often robbed in their taxis. Offenders often pretend to be passengers and instruct taxi drivers to drive to remote areas. When they were driven to a remote place, he or she threatens the drivers for money and valuables or even the taxi. The remoteness of the location makes it difficult for the police to find witnesses to identify the faces of the offenders. This often hinders investigation of the police.

In order to protect taxi drivers and assist the police in tracking offenders, some taxis are installed with analogue or digital surveillance systems. An analogue surveillance system comprises hidden video cameras and video recorders which saves video records taken by the video cameras in video tapes for future retrieval. Since video tapes require huge storage space and searching from them is difficult and time-consuming, digital surveillance system is used in most taxis nowadays. It makes use of a converter to convert analog signals into digital signals for transmission and storage. It reduces storage space, facilitates searching and enhances quality of the backup files. However, these digital surveillance systems are often required to operate continuously for onward recording and DDR or CD-Rom is therefore usually used for saving image backup files. This increases storage costs. Moreover, these systems have complicated operating procedures and lead to unsafe driving if taxi drivers are to drive and operate the system at the same time. Movement of the taxis also affects operation of the surveillance system and leads to malfunctioning.

Nevertheless, no matter an analogue or digital surveillance system is used, the recorded image backup files are saved inside the taxis. If an offender manages to damage the surveillance system in the taxi or the recorded image backup files, the evidence will be destroyed. The police thus cannot identify the identity of the offenders and the surveillance system loses its functions.

### BRIEF SUMMARY OF THE INVENTION

In view of the aforesaid disadvantages now present in the prior art, the present invention provides a surveillance system for application in taxis which can transmit the images to a central monitoring station for backup storage in real time so as to effectively prevent offenders from damaging or stealing recorded images stored inside the taxis and destroying evidence of crime. The system can be automatically switched on under predefined conditions, which ensures that the surveillance system only transmits and saves useful data. This reduces storage space and costs. In addition, safety is ensured since taxi drivers are not required to take care of any operating procedures when they are driving. Besides, the present invention is small and does not require a large storage space. Its shockproof device ensures that movement of the taxi does not hinder operation of the surveillance system.

To attain this, the present invention generally provides a surveillance system for application in taxis comprising hidden video camera(s), a server and a central monitoring station in a taxi, wherein the surveillance system comprises wireless networking facilities and an emergency switch installed in the taxi; the circuit board of the server has a microprocessor installed with software which automatically compresses temporary image backup files and transmits them by long-distance real time transmission via the wireless networking facilities to the central monitoring station for surveillance and permanent backup storage; the input/output terminals of the microprocessor connect to the input/output terminals of the video camera(s), the wireless networking facilities and the emergency switch.

The wireless networking facilities connect to a wireless transmission network available in the marketplace such as General Packet Radio Service (“GPRS”), High Speed Circuit Switched Data (“HSCSD”) or Cellular Digital Packet Data (“CDPD”) and others by real time networking.

The server is installed on a shockproof shelf so that movement of the taxi does not hinder operation of the server.

The emergency switch is installed at a place easily accessible by the driver.

There can be one or more video camera(s) which records the faces of the driver and passenger(s).

The power supply of the surveillance system is 12 volts.

The size of the server is less than 55 mm×200 mm×280 mm and the server weighs less than 1 kg so that it can be easily installed in a taxi.

The microprocessor has predefined operation procedures. When the taxi engine, taxi meter or emergency switch is activated, the surveillance system will be automatically switched on and the video camera(s) will start recording. The server compresses temporary image backup files recorded by the video camera(s), and transmits them via the wireless networking facilities to the central monitoring station in real time. The surveillance system operates for 10 to 30 seconds and stops automatically. This ensures that the surveillance system only transmits and saves useful data.

The microprocessor can be predefined to link data such as time and date with the recorded image backup files and automatically compress and transmit the image backup files using the data as parameters. Surveillance staff can therefore quickly retrieve image backup files using the parameters in the future.

The central monitoring station is provided with a monitor and surveillance staff can monitor the video images and the data linked to the images in real time through the monitor; the central monitoring station is also provided with a central processing unit which has a processor installed with software which automatically saves permanent backup files using the data as parameters and searches the backup files using the parameters.

The part of the server where recorded images are saved can be detached from the server and plugged onto a corresponding computer connecting station specially designed for the server to timely download the recorded images for backup purposes.

### BRIEF DESCRIPTION OF THE DRAWINGS

FIG. 1 shows an embodiment of the present invention.

### DETAILED DESCRIPTION OF THE INVENTION

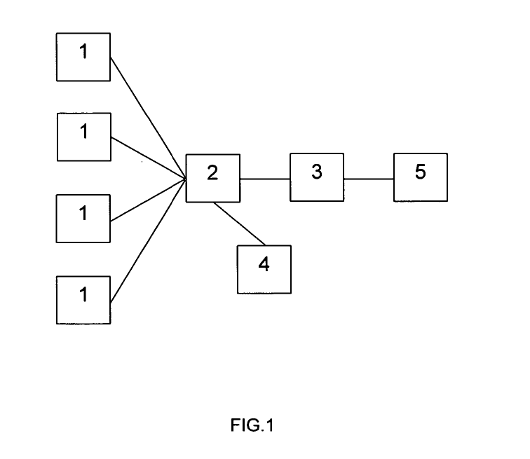

As illustrated in FIG. 1, the present invention comprises a surveillance system for application in taxis, the power supply of which is 12 volts. Four hidden video cameras 1, a server 2, wireless networking facilities 3, an emergency switch 4 are provided inside the taxi. The four hidden video cameras 1 are installed in hidden positions at the four corners of the taxi where the faces of the driver and passengers sitting in the front and back seats can be captured. The size of the server 2 is 50 mm×197 mm×272 mm and the server weighs 906 g. It can be installed at any position inside the taxi. The circuit board of the server 2 has a microprocessor installed with software which automatically links data such as time and date with the recorded image backup files. It automatically compresses the temporary image backup files of the video cameras 1 using the data as parameters and transmits them by wireless long-distance real time transmission via a GPRS to the central monitoring station 5 for surveillance and permanent backup storage. The input/output terminals of the microprocessor connect to the input/output terminals of the video cameras 1, the wireless networking facilities 3 and the emergency switch 4. The server 2 is installed on a shockproof shelf so that movement of the taxi does not hinder operation of the server 2. The emergency switch 4 is installed at a place easily accessible by the driver.

The surveillance system starts recording for 15 seconds when the taxi engine is started to record the face of the driver. If it is later found that someone has stolen the taxi, the record can be used to find the offender. Whenever the taxi driver starts the taxi meter, the surveillance system also starts recording for 15 seconds to record the faces of the driver and passengers. If the driver encounters emergency during a journey, he or she can press the emergency switch 4 to activate the surveillance system and immediately records the incident. This helps the police track the offender. The surveillance system can be automatically switched on or off so that only useful data are recorded. This reduces storage space and costs.

Through the monitor of the central monitoring station 5, surveillance staff can monitor the video images and the data linked to the images in real time. The central monitoring station 5 is also provided with a central processing unit which has a processor installed with software which automatically saves permanent backup files using the data as parameters and searches the backup files using the parameters.

Besides transmitting recorded images via the wireless networking facilities 3, the part of the server 2 where recorded images are saved can be detached from the server 2 and plugged onto a corresponding computer connecting station specially designed for the server to timely download the recorded images for backup.

What is claimed is:

1. A surveillance system for application in taxis comprising hidden video camera(s), a server and a central monitoring station in a taxi, wherein the surveillance system comprises wireless networking facilities and an emergency switch installed in the taxi; the circuit board of the server has a microprocessor installed with software which automatically compresses temporary image backup files and transmits them by long-distance real time transmission via the wireless networking facilities to the central monitoring station for surveillance and permanent backup storage; the input/output terminals of the microprocessor connect to the input/output terminals of the video camera(s), the wireless networking facilities and the emergency switch.

2. The surveillance system for application in taxis as in claim 1, wherein the wireless networking facilities connect to a wireless transmission network available in the marketplace such as General Packet Radio Service (“GPRS”), High Speed Circuit Switched Data (“HSCSD”) or Cellular Digital Packet Data (“CDPD”) and others by real time networking.

3. The surveillance system for application in taxis as in claim 1, wherein the server is installed on a shockproof shelf so that movement of the taxi does not hinder operation of the server.

4. The surveillance system for application in taxis as in claim 1, wherein the emergency switch is installed at a place easily accessible by the driver.

5. The surveillance system for application in taxis as in claim 1, wherein the power supply of the surveillance system is 12 volts.

6. The surveillance system for application in taxis as in claim 1, wherein the size of the server is less than 55 mm×200 mm×280 mm and the server weighs less than 1 kg so that it can be easily installed in a taxi.

7. The surveillance system for application in taxis as in claim 1, wherein the microprocessor has predefined operation procedures. When the taxi engine, taxi meter or emergency switch is activated, the surveillance system will be automatically switched on and the video camera(s) will start recording. The server compresses temporary image backup files recorded by the video camera(s), and transmits them via the wireless networking facilities to the central monitoring station in real time. The surveillance system operates for 10 to 30 seconds and stops automatically.

8. The surveillance system for application in taxis as in claim 1, wherein the microprocessor can be predefined to link data such as time and date with the recorded image backup files and automatically compress and transmit the image backup files using the data as parameters.

9. The surveillance system for application in taxis as in claim 1, wherein the central monitoring station is provided with a monitor and surveillance staff can monitor the video images and the data linked to the images in real time through the monitor; the central monitoring station is also provided with a central processing unit which has a processor installed with software which automatically saves permanent backup files using the data as parameters and searches the backup files using the parameters.

10. The surveillance system for application in taxis as in claim 1, wherein the part of the server where recorded images are saved can be detached from the server and plugged onto a corresponding computer connecting station specially designed for the server.
